(19) United States
(12) Patent Application Publication
(10) Pub. No.: US 2020/0256351 A1
(43) Pub. Date: Aug. 13, 2020

(54) CENTRIFUGAL PUMP AND RADIAL IMPELLER THEREFOR

(71) Applicant: BorgWarner Inc., Auburn Hills, MI (US)

(72) Inventor: Jeffrey J. ELSESSER, Marshall, MI (US)

(21) Appl. No.: 15/780,805

(22) PCT Filed: Nov. 28, 2016
(86) PCT No.: PCT/US2016/063811

§ 371 Date: Jun. 1, 2018

Related U.S. Application Data
(60) Provisional application No. 62/261,856, filed on Dec. 1, 2015.

(51) Int. Cl. F04D 29/24; F04D 29/62

(52) U.S. Cl. CPC F04D 29/24; F05B 2240/30; F05B 2230/21; F04D 29/62

(57) ABSTRACT

A centrifugal pump with a radial impeller having a first and second body portions and a plurality of impeller blades. The impeller blades are spaced circumferentially about the rotary axis and cooperate with the first and second body portions to define a plurality of flow channels. Each of the impeller blades has an axial leading edge and an axial trailing edge. At least a portion of each of the impeller blades has a rake that is contoured along the rotary axis of the radial impeller such that the axial trailing edge is offset in the first circumferential direction from the axial leading edge at meridional points along the portion of the impeller blade having the rake. A method for forming a radial impeller is also provided.

### FIELD

The present disclosure relates to centrifugal pumps and more particularly to a radial impeller for a centrifugal pump and a related method for forming a radial impeller.

### BACKGROUND

U.S. Pat. No. 6,139,274 discloses a radial impeller for a centrifugal pump that is suited to be manufactured by molding with mold halves that are movable towards one another axially with respect to the axis of the radial impeller. The mold is configured so that a first channel surface and parts of at least one rotor blade that are located outside of the smallest diameter of the first channel surface are formed by one mold half, while a second channel surface and parts of the at least one rotor blade that are located within the largest diameter of the second channel surface are formed by the other mold half. Configuration in this manner eliminates the need for one or more mold cores that are disposed perpendicular to the rotary axis of the radial impeller, and as such, permits the radial impeller to be formed with a relatively uncomplicated and inexpensive mold.

Unfortunately, configuration of a radial impeller in this manner is limited to radial impellers having impeller blades that do not have rake or an inclination of the impeller blade (relative to the rotary axis of the radial impeller) in the circumferential direction. Rake of an impeller blade contours the profile of the impeller blade in a circumferential direction so that sides of the impeller blade are inclined or angled relative to the rotary axis of the radial impeller to match the relative motion of the impeller and the incoming fluid. Consequently, a forming process such as that described in U.S. Pat. No. 6,139,274 cannot be employed because the radial impeller formed in the cavity of the mold would lock the mold halves together.

### SUMMARY

This section provides a general summary of the disclosure, and is not a comprehensive disclosure of its full scope or all of its features.

In one form, the present teachings provide a centrifugal pump with a radial impeller having a first body portion, a second body portion and a plurality of impeller blades. The first body portion has a hub and a first shroud. The hub defines a rotary axis. The first shroud is fixedly coupled to the hub and extends therefrom in a first axial direction along the rotary axis with increasing distance from the hub in a radial direction. The second body portion has an annular flange and a second shroud. The annular flange is disposed concentrically about the hub. The second shroud is fixedly coupled to the annular flange and extends therefrom in a second axial direction along the rotary axis that is opposite the first axial direction. The second shroud defines an inlet aperture. The impeller blades couple the first body portion to the second body portion. The impeller blades are spaced circumferentially about the rotary axis and cooperate with the first and second body portions to define a plurality of flow channels. Each of the impeller blades has an axially leading end, which is located within the inlet aperture, and a trailing end that terminates at a peripheral edge of the annular flange. Each of the impeller blades further has an axial leading edge and an axial trailing edge. The impeller blades have a radially curving profile such that each of the impeller blades curves in a first circumferential direction about the rotary axis between their leading end and their trailing end. At least a portion of each of the impeller blades also has a rake that is contoured along the rotary axis such that the axial trailing edge is offset in the first circumferential direction from the axial leading edge at meridional points along the portion of the impeller blade having the rake. The first shroud has an outer peripheral surface with a first diameter. The inlet aperture has a second diameter. The first diameter is less than or equal to ninety percent of the second diameter.

In another form, the present teachings provide a method for fabricating a centrifugal pump. The method includes providing a mold having first and second cores, the mold defining a cavity, the cavity being configured to define a radial impeller having a first body portion, a second body portion and a plurality of impeller blades, the first body portion having a hub and a first shroud, the hub defining a rotary axis, the first shroud being fixedly coupled to the hub and extending therefrom in a first axial direction along the rotary axis with increasing distance from the hub in a radial direction, the second body portion having an annular flange and a second shroud, the annular flange being disposed concentrically about the hub, the second shroud being fixedly coupled to the annular flange and extending therefrom in a second axial direction along the rotary axis that is opposite the first axial direction, the second shroud defining an inlet aperture, the impeller blades coupling the first body portion to the second body portion, the impeller blades being spaced circumferentially about the rotary axis and cooperating with the first and second body portions to define a plurality of flow channels, each of the impeller blades having a leading end, which is located within the inlet aperture, and a trailing end that terminates at a peripheral edge of the annular flange, each of the impeller blades further having an axial leading edge and an axial trailing edge, the impeller blades having a radially curving profile such that each of the impeller blades curves in a first circumferential direction about the rotary axis between their leading end and their trailing end, wherein at least a portion of each of the impeller blades also having a rake that is contoured along the rotary axis such that the axial trailing edge is offset in the first circumferential direction from the axial leading edge at meridional points along the portion of the impeller blade having the rake; filling the cavity with a material to form the first and second body portions and the impeller blades of the radial impeller; moving the first core relative to the second core parallel to the rotary axis to open the mold; rotating the radial impeller about the rotary axis relative to the second core; and removing the radial impeller from the mold. The first shroud has an outer peripheral surface with a first diameter, the inlet aperture has a second diameter, and the first diameter is less than or equal to ninety percent of the second diameter.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1A is a rear elevation view of a radial impeller that is constructed in accordance with the teachings of the present disclosure;

FIGS. 1B and 1C are perspective views of the radial impeller of FIG. 1A from front and rear orientations, respectively;

FIG. 2 is a cross-sectional view taken along the line 2-2 of FIG. 1A;

FIG. 3 is a side elevation view of the radial impeller of FIG. 1A;

FIG. 4 is a cross-sectional view taken along the line 4-4 of FIG. 1A;

FIG. 5 is front elevation view of the radial impeller of FIG. 1A;

FIG. 6A is a cross-sectional view taken along the line 6A-6A of FIG. 5;

FIG. 6B is a cross-sectional view taken along the line 6B-6B of FIG. 5;

FIG. 6C is a cross-sectional view taken along the line 6C-6C of FIG. 5;

FIG. 6D is a cross-sectional view taken along the line 6D-6D of FIG. 5;

FIG. 6E is a cross-sectional view taken along the line 6E-6E of FIG. 5;

FIG. 7 is a cross-sectional view of a centrifugal pump that incorporates the radial impeller of FIG. 1A;

FIG. 8 is a cross-sectional view of a mold for manufacturing the radial impeller of FIG. 1A; and

FIG. 9 is an enlarged portion of FIG. 8.

Corresponding reference numerals indicate corresponding parts throughout the several views of the drawings.

### DETAILED DESCRIPTION

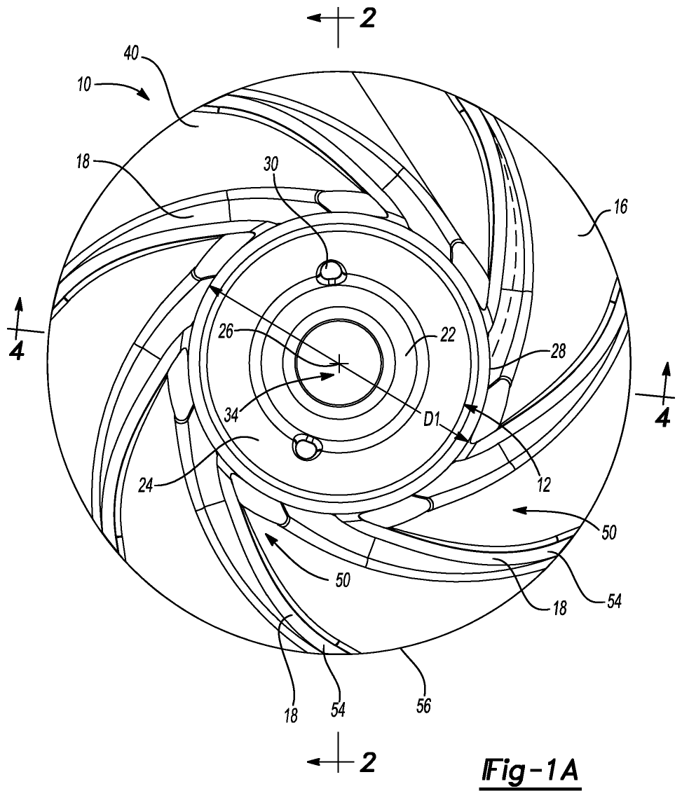

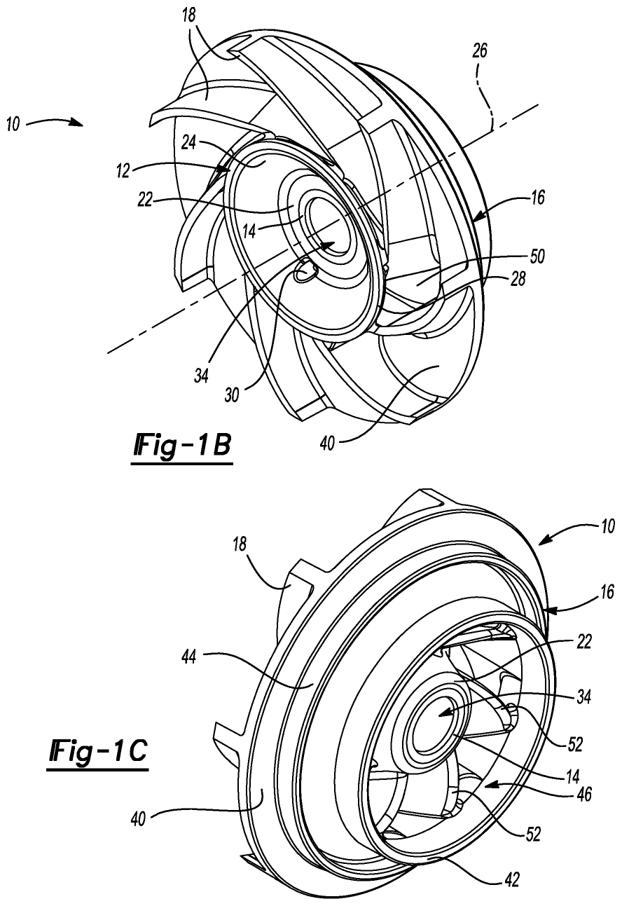

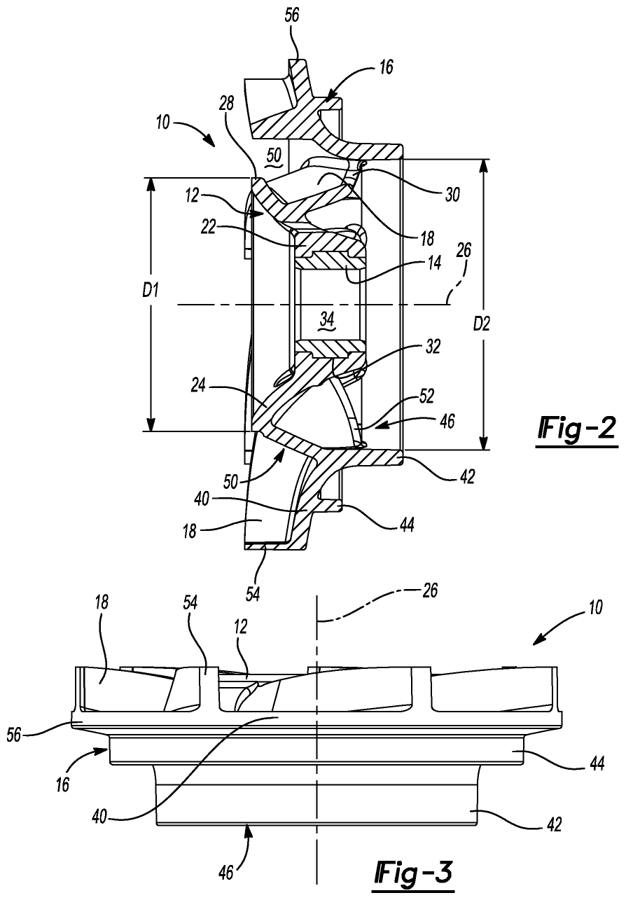

With reference to FIGS. 1A through 3, an exemplary radial impeller constructed in accordance with the teachings of the present disclosure is generally indicated by reference numeral 10. The radial impeller 10 can have a first body portion 12, a bushing 14, a second body portion 16 and a plurality of impeller blades 18. The first and second body portions 12 and 16 and the impeller blades 18 are configured to be unitarily and integrally formed by casting or molding.

The first body portion 12 can have a hub 22 and a first shroud 24. The hub 22 is configured to be mounted to a shaft (not shown) of a centrifugal pump (not shown) and defines a rotary axis 26. The first shroud 24 is fixedly coupled to the hub 22 and extends therefrom in a first axial direction along the rotary axis 26 with increasing distance from the hub 22 in a radial direction. The first shroud 24 can be configured in any desired manner, but in the particular example provided the first shroud 24 is frusto-conically shaped and diverges outwardly from the hub 22. The first shroud 24 has an outer peripheral surface 28 with a first diameter D1. Optionally, one or more pressure balancing apertures 30 can be formed through the first shroud 24. As is known in the art, the pressure balancing apertures 30 are employed to balance thrust loads on the radial impeller 10 that are generated during operation of a centrifugal pump (not shown). Optionally, the pressure balancing apertures 30 can be disposed at locations that aid in rotationally balancing the radial impeller 10 about the rotary axis 26 (i.e., aligning the center of gravity of the radial impeller 10 to the rotary axis 26).

The bushing 14 is received in the hub 22 and can be fixedly coupled thereto in any desired manner. In the example provided, the bushing 14 is formed from bar stock having a non-circular cross-sectional shape (e.g., generally octagonal) with a includes a flats 32 (FIG. 2) that are formed about an outer periphery of the bushing 14 and the hub 22 is overmolded onto the bushing 14 so that the material that forms the hub 22 encapsulates at least a portion of the bushing 14 and is cohesively bonded to the bushing 14. In the example provided, the flats 32 on the bushing 14 are encapsulated into the material that forms the hub 22 and as such, further rotatably couple the bushing 14 to the hub 22 to inhibit relative rotation there between. The bushing 14 is configured to be mounted on a shaft of a centrifugal pump and can define a mounting aperture 34 that can be configured to engage the shaft in any desired manner, such as slip fit or an interference fit. Alternatively, the mounting aperture 34 can define a plurality of internal threads (not shown) that can be threaded onto a plurality of external threads (not shown) on the shaft.

The second body portion 16 can have an annular flange 40, a second shroud 42 and a third shroud 44. The annular flange 40 is disposed concentrically about the hub 22. The second shroud 42 is fixedly coupled to the annular flange 40 and extends therefrom in a second axial direction along the rotary axis 26 that is opposite the first axial direction. The second shroud 42 defines an inlet eye or inlet aperture 46 that has a second diameter D2. The second diameter D2 is larger than the first diameter D1. Preferably, the first diameter D1 is less than or equal to ninety percent of the second diameter D2. The third shroud 44, which is optional, can extend from the annular flange 40 in the second direction along the rotary axis 26 and can be disposed concentrically about the second shroud 42.

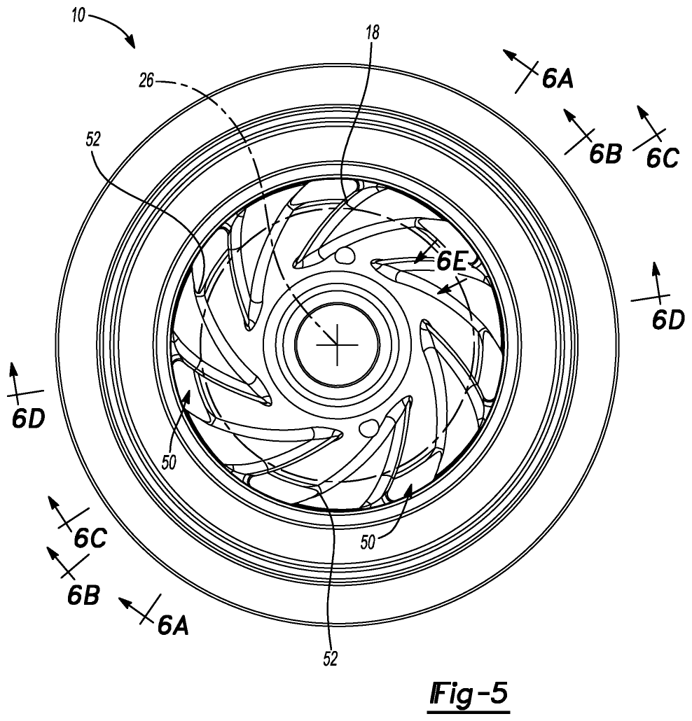

With reference to FIGS. 1A, 2 and 4, the impeller blades 18 can couple the first body portion 12 to the second body portion 16. While any number of impeller blades 18 can be employed, configurations that use a quantity of impeller blades that is equal to or greater than five and less than or equal to ten are generally most efficient. The portion of the impeller blades 18 disposed on the inlet side of the annular flange 40 (i.e., the portion of the impeller blades 18 disposed in the inlet aperture 46) can be referred to as being the “interior blade portion”, while the portion of the impeller blades 18 dispose don the outlet side of the annular flange 40 can be referred to as being the “exterior blade portion”. The impeller blades 18 can be spaced circumferentially about the rotary axis 26 and can cooperate with the first and second body portions 12 and 16 to define a plurality of flow channels 50. Each of the impeller blades 18 has a leading end 52, which is located within the inlet aperture 46, and a trailing end 54 that terminates at a peripheral edge 56 of the annular flange 40. Each of the impeller blades 18 further has an axial leading edge 60 (FIGS. 5-7) and an axial trailing edge 62 (FIGS. 5-7). If pressure balancing apertures 30 are employed, each of the pressure balancing apertures 30 intersects an associated one of the flow channels 50.

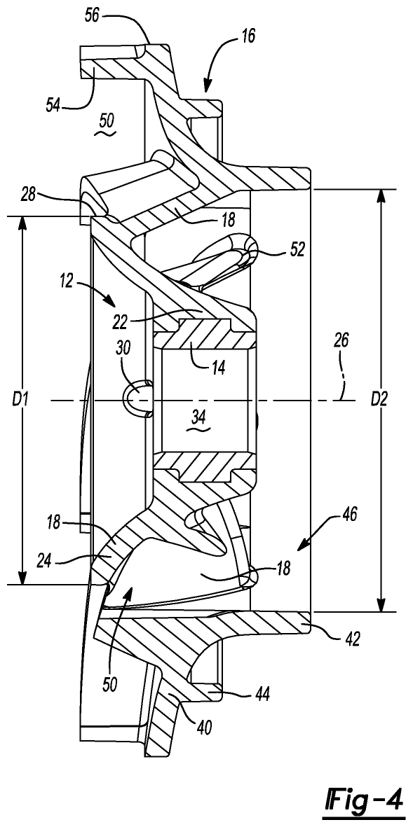

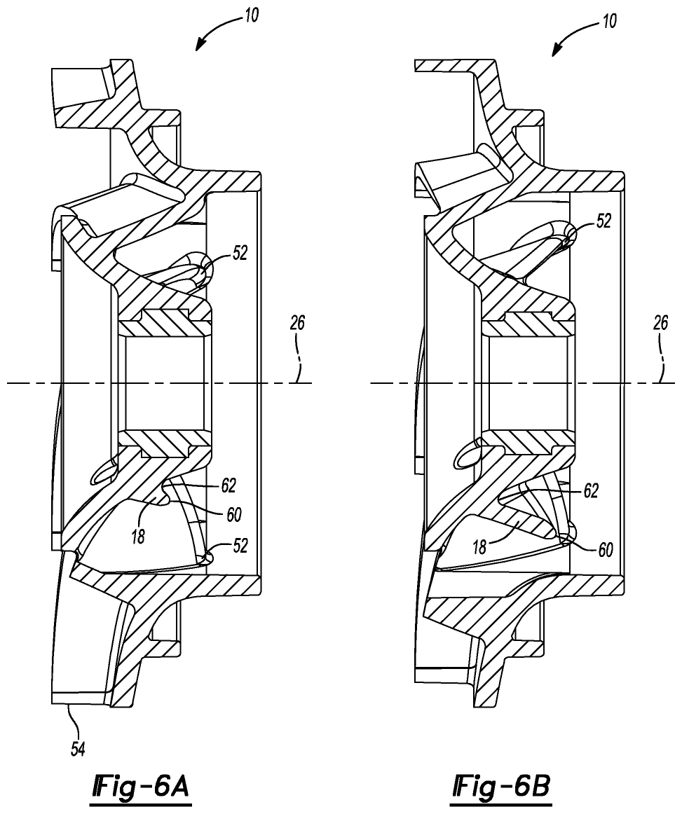

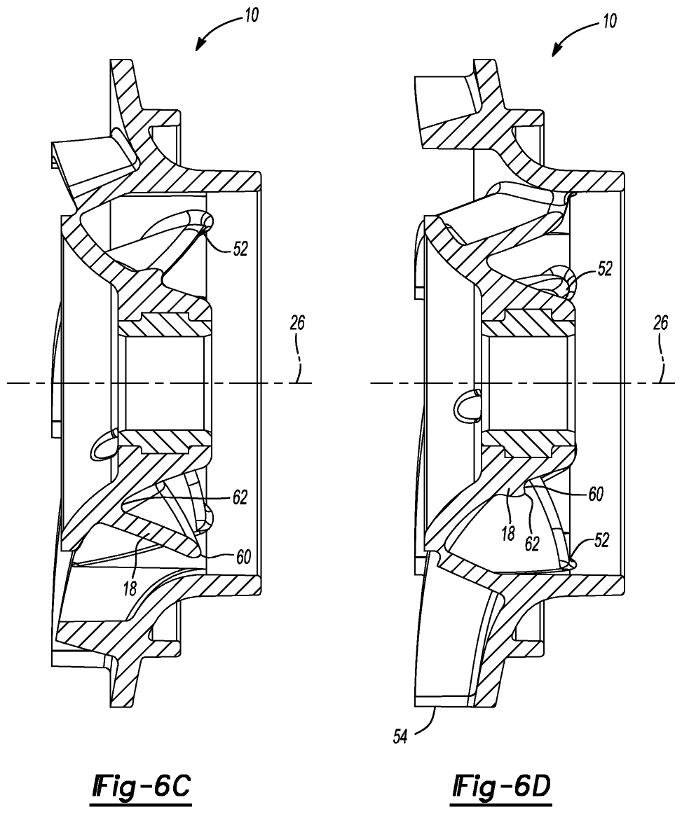

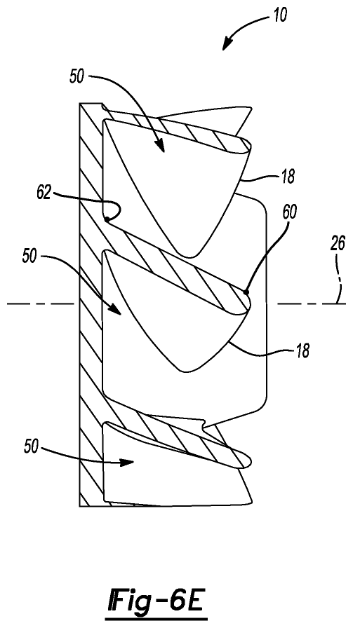

With reference to FIGS. 1A, 4 and 5, the impeller blades 18 are formed with a radially curving profile (e.g., spiral profile) such that each of the impeller blades 18 curves in a first circumferential direction about the rotary axis 26 between their leading end 52 and their trailing end 54. As best shown in FIGS. 5 and 6E, at least a portion of each of the impeller blades 18 also has a rake that is contoured along the rotary axis 26 such that the axial trailing edge 62 is offset in the first circumferential direction from the axial leading edge 60 at meridional points along the portion of the impeller blade 18 that has the rake. In the particular example provided, the rake is disposed only on the interior blade portion that is disposed within the second diameter D2 (FIG. 4) and a magnitude of the rake increases with decreasing distance to the peripheral edge 56 of the annular flange 40. It will be appreciated that additionally or alternatively, the rake can be formed on the exterior blade portion.

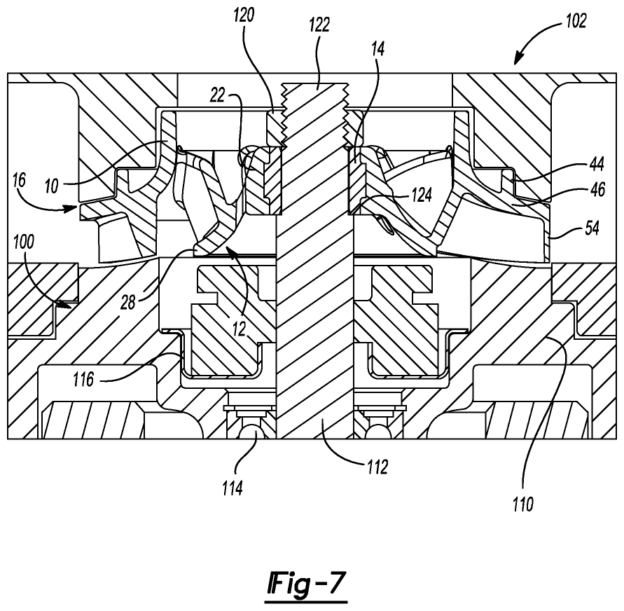

In FIG. 7, a cross-sectional view of an exemplary centrifugal pump 100 is illustrated. The pump 100 is depicted in operative association with a conventional internal combustion engine 102 and is configured to create a flow of coolant that is discharged into the water jacket (not specifically shown) of the internal combustion engine.

The pump 100 includes a pump housing 110, a shaft 112, a bearing 114 and a shaft seal 116. The shaft 112 is received in the pump housing 110 and is supported for rotation about the rotary axis 26 relative to the pump housing 110 by the bearing 114. The radial impeller 10 can be coupled to the shaft 112 for rotation therewith. Any desired means can be employed to fix the radial impeller 10 to the shaft 112, such as a nut 120 that can be threaded to an externally threaded portion 122 of the shaft 112 to provide a clamping force that is exerted through hub 22 to a shoulder 124 formed on the shaft 112 to non-rotatably couple the hub 22 of the radial impeller 10 to the shaft 112.

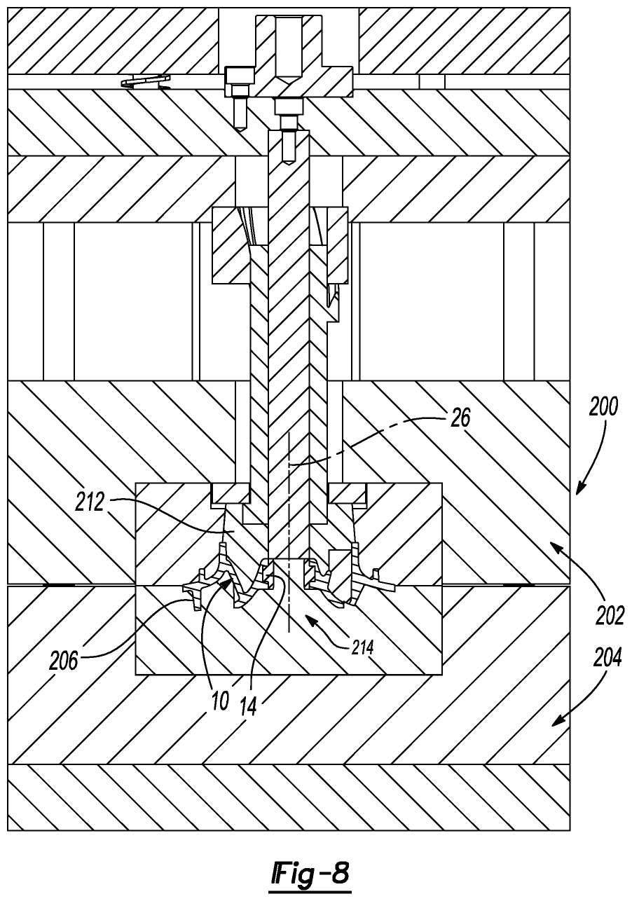

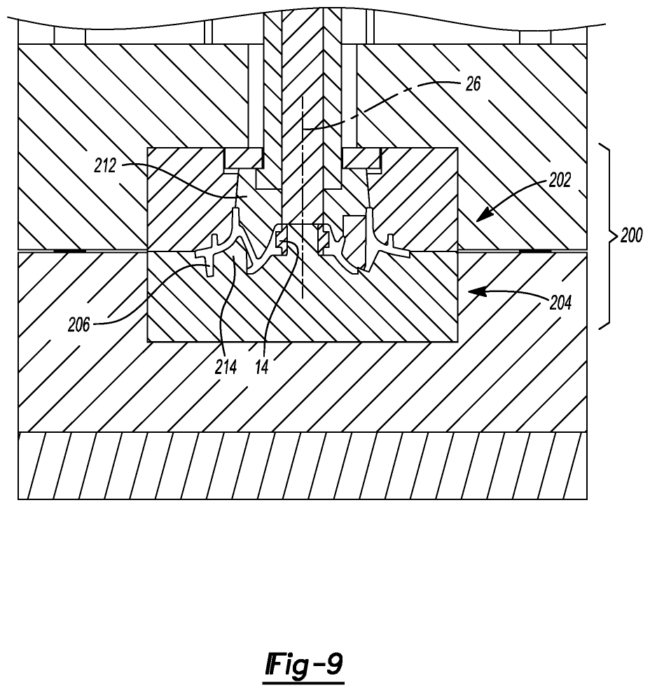

In FIGS. 8 and 9, an exemplary mold 200 for forming the radial impeller 10 of FIG. 1 is illustrated. The mold 200 includes first and second mold half assemblies 202 and 204 and defines a cavity 206 that is configured to form the first and second body portions 12 and 16 (FIG. 2) and the impeller blades 18 (FIG. 2) of the radial impeller 10. If components, such as the bushing 14, are to be incorporated into the radial impeller 10, the mold 200 can include various features to hold such components in position during the molding/casting operation.

The first mold half assembly 202 can be movable along the rotary axis 26 of the radial impeller 10 relative to the second mold half assembly 204. The first mold half assembly 202 can include a first core 212 that is configured to define various features on a first side of the radial impeller 10, such as the first shroud 24 (FIG. 2), a first side of the annular flange 40 (FIG. 2), and the portion of the impeller blades 18 (FIG. 2) that extends from the first side of the annular flange 40 (FIG. 2). The second mold half assembly 204 can include a second core 214 that is configured to define various features on a second side of the radial impeller 10 that is opposite the first side of the radial impeller 10, such as the second and third shrouds 42 and 44 (FIG. 2), a second side of the annular flange 40 (FIG. 2), and the portion of the impeller blades 18 (FIG. 2) that extends from the second side of the annular flange 40 (FIG. 2).

The cavity 206 in the mold 200 can be filled (e.g., injected) with a molten material, such as a suitable plastic or metal material, to form the first and second body portions 12 and 16 and the impeller blades 18 of the radial impeller 10. After the material that has been injected into the cavity 206 has solidified, the mold 200 can be opened to remove the radial impeller 10. Opening of the mold 200 includes relative movement between the first and second mold half assemblies 202 and 204 along the rotary axis 26 of the radial impeller 10, and may also include relative rotation between the first and second cores 212 and 214 about the rotary axis 26. It will be appreciated that due to the use of rake in the configuration of the impeller blades 18, the first core 212 is locked to the radial impeller 10 so that it would not be possible to eject the radial impeller 10 merely by opening the mold 200 through relative movement between the first and second mold half assemblies 202 and 204 along the rotary axis 26 of the radial impeller 10. To “unlock” the radial impeller 10 from the first mold half assembly 202, it is necessary to provide relative rotation between the first core 212 and the radial impeller 10. The may be accomplished by coordinating rotational movement about the rotary axis 26 with any of the first and second cores 212 and 214 that is moved axially along the rotary axis 26 relative to the radial impeller 10. In the example provided, a rotary cam mechanism is employed in the first mold half assembly 202, but it will be appreciated that various other mechanisms, such as gearing or a drive that employs a motor and chain, could be employed. While only the first core 212 moves both axially and rotationally relative to the radial impeller 10 in the example provided, it will be understood that in the alternative (such as when both the interior and exterior blade portions are configured with rake), both the first and second cores 212 and 214 can be moved in both opposite axial directions along the rotary axis 26 and opposite rotational directions about the rotary axis 26. It will also be appreciated that where rake is provided on only one of the interior and exterior blade portions, it is possible to open the mold and then remove the radial impeller 10 by rotating the radial impeller 10 relative to an associated one of the mold halves, either manually or via a mechanism such as a robot.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A centrifugal pump (100) comprising:
a radial impeller (10) having a first body portion (12), a second body portion (16) and a plurality of impeller blades (18);
the first body portion (12) having a hub (22) and a first shroud (24), the hub (22) defining a rotary axis (26), the first shroud (24) being fixedly coupled to the hub (22) and extending therefrom in a first axial direction along the rotary axis (26) with increasing distance from the hub (22) in a radial direction;
the second body portion (16) having an annular flange (40) and a second shroud (42), the annular flange (40) being disposed concentrically about the hub (22), the second shroud (42) being fixedly coupled to the annular flange (40) and extending therefrom in a second axial direction along the rotary axis (26) that is opposite the first axial direction, the second shroud (42) defining an inlet aperture (46); and
the impeller blades (18) coupling the first body portion (12) to the second body portion (16), the impeller blades (18) being spaced circumferentially about the rotary axis (26) and cooperating with the first and second body portions (12) and (16) to define a plurality of flow channels (50), each of the impeller blades (18) having an axially leading end (52), which is located within the inlet aperture (46), and a trailing end (54) that terminates at a peripheral edge (56) of the annular flange (40), each of the impeller blades (18) further having an axial leading edge (60) and an axial trailing edge (62), the impeller blades (18) having a radially curving profile such that each of the impeller blades (18) curves in a first circumferential direction about the rotary axis (26) between their leading end (52) and their trailing end (54), wherein at least a portion of each of the impeller blades (18) also having a rake that is contoured along the rotary axis (26) such that the axial trailing edge (62) is offset in the first circumferential direction from the axial leading edge (60) at meridional points along the portion of the impeller blade (18) having the rake;
wherein the first shroud (24) has an outer peripheral surface (28) with a first diameter (D1), wherein the inlet aperture (46) has a second diameter (D2), and wherein the first diameter (D1) is less than or equal to ninety percent of the second diameter (D2).

2. The centrifugal pump (100) of claim 1, wherein the portion of the impeller blades (18) having rake is limited to a portion of the impeller blades (18) that is disposed within the inlet aperture (46).

3. The centrifugal pump (100) of claim 1, wherein the radial impeller (10) further comprises a bushing (14) that is received in the hub (22).

4. The centrifugal pump (100) of claim 3, wherein the bushing (14) is at least partly encapsulated into a plastic material that forms the hub (22).

5. The centrifugal pump (100) of claim 1, wherein the impeller blades (18) number between 5 and 10, inclusive, in quantity.

6. The centrifugal pump (100) of claim 1, wherein the second body portion (16) of the radial impeller (10) further comprises a third shroud (44) that extends from the annular flange (40) in the second direction along the rotary axis (26), the third shroud (44) being disposed concentrically about the second shroud (42).

7. The centrifugal pump (100) of claim 1, wherein the first shroud (24) is frusto-conically shaped and diverges outwardly from the hub (22).

8. The centrifugal pump (100) of claim 1, wherein a magnitude of the rake increases with decreasing distance to the peripheral edge (56) of the annular flange (40).

9. The centrifugal pump (100) of claim 1, further comprising a pump housing (110) and a shaft (112), the shaft (112) being rotatably mounted to the pump housing (110), the radial impeller (10) being coupled to the shaft (112) for rotation therewith.

10. The centrifugal pump (100) of claim 1, wherein one or more pressure balancing apertures (30) are formed through the first shroud (24), each of the pressure balancing apertures (30) intersecting an associated one of the flow channels (50).

11. A method for fabricating a centrifugal pump (100), the method comprising:
providing a mold (200) having first and second cores (212) and (214), the mold (200) defining a cavity (206), the cavity (206) being configured to define a radial impeller (10) having a first body portion (12), a second body portion (16) and a plurality of impeller blades (18), the first body portion (12) having a hub (22) and a first shroud (24), the hub (22) defining a rotary axis (26), the first shroud (24) being fixedly coupled to the hub (22) and extending therefrom in a first axial direction along the rotary axis (26) with increasing distance from the hub (22) in a radial direction, the second body portion (16) having an annular flange (40) and a second shroud (42), the annular flange (40) being disposed concentrically about the hub (22), the second shroud (42) being fixedly coupled to the annular flange (40) and extending therefrom in a second axial direction along the rotary axis (26) that is opposite the first axial direction, the second shroud (42) defining an inlet aperture (46), the impeller blades (18) coupling the first body portion (12) to the second body portion (16), the impeller blades (18) being spaced circumferentially about the rotary axis (26) and cooperating with the first and second body portions (12) and (16) to define a plurality of flow channels (50), each of the impeller blades (18) having a leading end (52), which is located within the inlet aperture (46), and a trailing end (54) that terminates at a peripheral edge (56) of the annular flange (40), each of the impeller blades (18) further having an axial leading edge (60) and an axial trailing edge (62), the impeller blades (18) having a radially curving profile such that each of the impeller blades (18) curves in a first circumferential direction about the rotary axis (26) between their leading end (52) and their trailing end (54), wherein at least a portion of each of the impeller blades (18) also having a rake that is contoured along the rotary axis (26) such that the axial trailing edge (62) is offset in the first circumferential direction from the axial leading edge (60) at meridional points along the portion of the impeller blade (18) having the rake, wherein the first shroud (24) has an outer peripheral surface (28) with a first diameter (D1), wherein the inlet aperture (46) has a second diameter (D2), and wherein the first diameter (D1) is less than or equal to ninety percent of the second diameter (D2);
filling the cavity (206) with a material to form the first and second body portions (12) and (16) and the impeller blades (18) of the radial impeller (10);
moving the first core (212) relative to the second core (214) parallel to the rotary axis (26) to open the mold (200);
rotating the radial impeller (10) about the rotary axis (26) relative to the second core (214); and
removing the radial impeller (10) from the mold (200).

12. The method of claim 11, wherein prior to filling the cavity (206) the method further comprises:
mounting a bushing (14) to the mold (200); and
closing the mold (200) such that the bushing (14) is disposed in the cavity (206).

13. The method of claim 11, wherein the first and second cores (212) and (214) are moved in both opposite axial directions along the rotary axis (26) and opposite rotational directions about the rotary axis (26) relative to the radial impeller (10) to open the mold (200).

14. The method of claim 11, wherein rotating the impeller (10) about the rotary axis (26) relative to the second core (214) takes place when the first core (212) is moved relative to the second core (214) to open the mold (200).
